(19) United States
(12) Patent Application Publication
(10) Pub. No.: US 2008/0116854 A1
(43) Pub. Date: May 22, 2008

(54) CURRENT CONTROL IN RECHARGEABLE ELECTRONIC DEVICES

(75) Inventor: Jeong-gyu PARK, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/854,031

(22) Filed: Sep. 12, 2007

(30) Foreign Application Priority Data
Nov. 20, 2006 (KR) 2006-114836

(51) Int. Cl. H02J 7/00; H01M 10/44

(52) U.S. Cl. 320/160

(57) ABSTRACT

A system part of an electronic device a plurality of electronic components, and a power supply supplies power from an external source to the system part is connected to a battery at a power supply line between the power supply and the system part. The battery provides auxiliary power to the system part and requires a recharge when it has been discharged. A switch is provided to selectively connect the power supply line to the battery under the control of a controller which controls the switch according to a charge level of the battery.

### CROSS-REFERENCE TO RELATED APPLICATIONS

This application claims benefit of priority under 35 U.S.C. 119(a) from Korean Patent Application No. 2006-0114836, filed on Nov. 20, 2006, in the Korean Intellectual Property Office, the disclosure of which is incorporated herein in its entirety by reference.

### BACKGROUND OF THE INVENTION

1. Field of the Invention

Apparatuses and methods consistent with the present general inventive concept relate to power control in electronic devices that charge batteries from which they derive power.

2. Description of the Related Art

Generally, a portable computer, such as a laptop computer and a personal digital assistant (PDA), can be used while in motion. Such an electronic device can use external power through an AC/DC adaptor or the like, or a secondary battery which is recharged with power from the adapter.

Among developing technologies relating to batteries of the portable computer, extended battery life (EBL) research is being conducted. For example, narrow VDC (NVDC) is a technology that lowers a voltage level of input power (VDC) to a DC/DC converter converting power from an adaptor or a battery into power at a voltage level compatible with the requirements of components of a system part.

In a conventional computer that applies the NVDC technology, a power supply supplies power from the adaptor to both the system part and the battery. That is, the system part and the battery receive power from a single power supply.

As the power supply of the conventional computer supplies power to both the system part and the battery at the same time, the system part can not receive power independently of the battery even when the battery is fully charged and the power is no longer supplied to the battery.

The rechargeable battery should be precharged after it has been completely discharged and prior to recharging to extend its life span. However, in the conventional computer applying the NVDC technology, the battery is charged with power directly branched from a certain point on a power supply line to the system part, and thus a small amount of current to precharge the battery is not available.

### SUMMARY OF THE INVENTION

The present general inventive concept provides an electronic device which includes a switch to be switched on and off to charge and discharge a battery, and a current adjuster which adjusts an amount of a charging current, so that power supplied to the battery is cut off if the battery is fully charged, and a small current to precharge the battery is supplied thereto if the battery is completely discharged, to extend the life span of the battery, and a power control method thereof.

Additional aspects and utilities of the present general inventive concept will be set forth in part in the description which follows and, in part, will be obvious from the description, or may be learned by practice of the present general inventive concept.

The foregoing and/or other aspects of the present general inventive concept are achieved by providing a computer, comprising a system part which comprises a plurality of electronic components, a power supply which supplies power to the system part, a battery which is connected to a power supply line between the power supply and the system part, and provides auxiliary power to the system part, a switch to selectively connect the power supply line to the battery, and a controller which controls the switch to charge the battery according to a charge level of the battery.

The controller may open the switch to stop charging the battery if the charge level of the battery is higher than a first predetermined value.

The computer may further comprise a current adjuster which receives power from the power supply and adjusts an amount of a charging current to be supplied to the battery, wherein the controller controls the current adjuster to adjust the amount of the charging current to be supplied to the battery if the charge level of the battery is lower than a second predetermined value.

The computer may further comprise a comparator, wherein the controller controls the current adjuster to adjust the amount of the charging current to be supplied to the battery if the charge level of the battery is lower than the second predetermined value according to a comparison result of the comparator.

Each of the current adjuster and the switch may comprise a transistor which is turned on and off by a control signal from the controller.

The computer may further comprise a power detector which detects whether power is supplied from an external source, wherein the controller controls the power supply to receive power from the external source if the power detector detects that power is provided therefrom.

The system part may comprise a DC/DC converter which lowers a level of power supplied from the power supply.

The foregoing and/or other aspects of the present general inventive concept are also achieved by providing a computer, comprising a system part which comprises a plurality of electronic components, a power supply which supplies power to the system part, a battery which is connected to a power supply line between the power supply and the system part, and provides auxiliary power to the system part, a current adjuster which receives power from the power supply and adjusts an amount of a charging current to be supplied to the battery, and a controller which controls the current adjuster to adjust the amount of the charging current to be supplied to the battery if a charge level of the battery is lower than a predetermined value.

The controller may control the current adjuster to adjust the amount of the charging current to be supplied to the battery if the charge level of the battery is lower than the predetermined value according to a comparison result of the comparator.

The current adjuster may comprise a transistor which is turned on and off by a control signal from the controller.

The computer may further comprise a power detector which detects whether power is supplied from an external source, wherein the controller controls the power supply to receive power from the external source if the power detector detects that power is provided therefrom.

The system part may comprise a DC/DC converter which lowers a level of the power supplied from the power supply.

The foregoing and/or other aspects of the present general inventive concept are also achieved by providing a method of controlling power of a computer which includes a system part having a plurality of electronic components, and a battery, comprising receiving power from an external source, determining a charge level of the battery, and selectively connecting a power supplying line supplying to the battery according to the determined charge level of the battery.

The selectively connecting the power supply line to the battery may comprise terminating charging the battery by disconnecting the power supply line from the battery if the charge level of the battery is higher than a first predetermined value.

The selectively connecting the power supply line to the battery may comprise adjusting an amount of a charging current to be supplied to the battery when the charge level of the battery is lower than a second predetermined value.

The receiving of the power from the external source may further comprise detecting whether the power is input from the external source, and receiving power from the external source if the input power is detected.

The foregoing and/or other aspects of the present general inventive concept are also achieved by providing a method of controlling power of a computer which includes a system part having a plurality of electronic components, and a battery, comprising receiving power from an external source, determining a charge level of the battery, and adjusting an amount of a charging current to be supplied to the battery according to the determined charge level of the battery.

The adjusting the amount of the charging current may comprise adjusting the intensity of the amount of the charging current to the battery if the charge level of the battery is lower than a predetermined value.

The foregoing and/or other aspects and utilities of the present general inventive concept are also achieved by providing an in situ battery charging apparatus comprising a power supply to provide power to a system circuit and a battery that provides auxiliary power to the system circuit, and a switch electrically interposed between the system circuit and the battery, the switch to be operated into a conducting state to provide a charging current to the battery from the power supply and a non-conducting state to remove the charging current from the battery responsive to a first charge level of the battery.

The foregoing and/or other aspects and utilities of the present general inventive concept are also achieved by providing a method for charging a battery from power delivered to a system part of an electronic device, the method comprising providing a operating current to the system part and a charging current to the battery from a common power supply receiving power from an external source, and adjusting the charging current between a maximum amount and a zero amount responsive to a charge level of the battery.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIGS. 1 and 2 are block diagrams of a computer according to exemplary embodiments of the present general inventive concept;

FIG. 3 is a detailed circuit diagram of the computer according to an exemplary embodiment of the present general inventive concept; and

FIG. 4 is a flowchart of a power control method of the computer according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

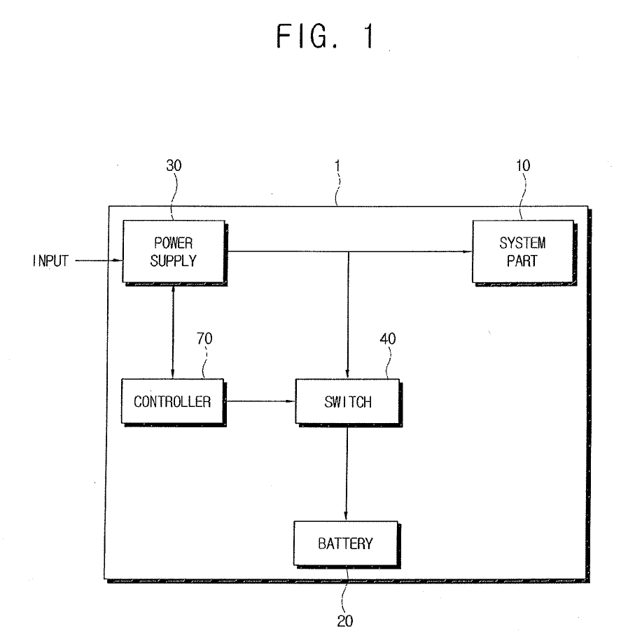

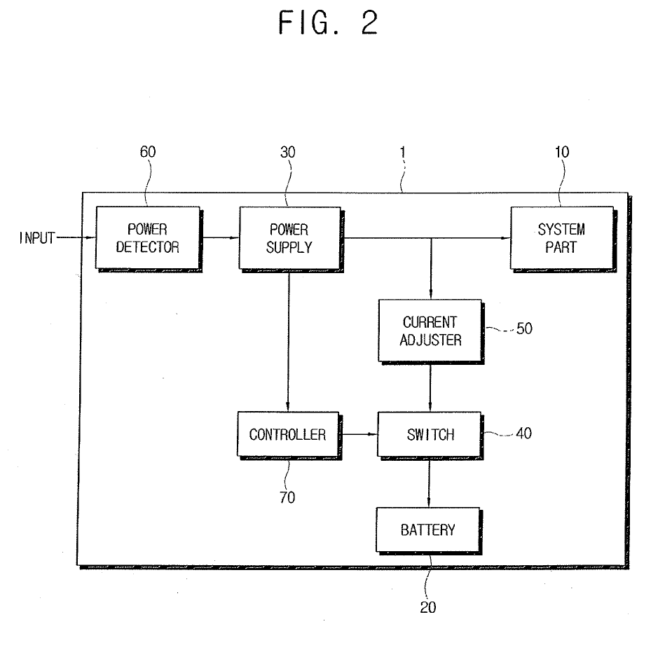

FIGS. 1 and 2 are block diagrams of a computer 1 according to an exemplary embodiment of the present general inventive concept. It is to be understood that while the illustrated embodiments below are of a computer, other devices may be used with the present invention without departing from the spirit and intended scope of the present general inventive concept.

As illustrated in FIGS. 1 and 2, the exemplary computer 1 includes a system part 10, a battery 20, which may be mountable from the outside the computer housing, a power supply 30, a switch 40 and a controller 70. The computer 1 may be embodied as a portable computer, such as a laptop computer or a personal digital assistant (PDA), as well as numerous other processor-based systems that operate from rechargeable batteries. FIG. 2 illustrates a computer 1 according to another exemplary embodiment of the present general inventive concept, which further includes a current adjuster 50 and a power detector 60.

The system part 10 may include a plurality of electronic components to perform main functions of the computer 1 using the supplied power. If the present general inventive concept is embodied in a portable computer, the electronic components of the system part 10 may include a central processing unit (CPU), a random access memory (RAM), a chipset, a main board, a graphic card, etc.

The system part 10 may include a DC/DC converter (not illustrated) which converts power from the power supply into power at a voltage level compatible with driving the respective electronic components to which the converted power is provided. The DC/DC converter may include a switching voltage regulator to generate power at various voltage levels.

The battery 20 may be embodied in a secondary battery which is chargeable by the power supply 30, as will be described in paragraphs that follow. The battery 20, according to an exemplary embodiment of the present general inventive concept, may be tapped into a power supply line between the power supply 30 and the system part 10, and may be charged from the power supply 30 and while concurrently providing auxiliary power to the system part 10. The battery 20 may be constructed from a single cell, but may also include multiple battery cells having respective specifications on charging and output voltages. The battery 20 may be charged in situ, i.e., while the system part 10 is operating under the power of the power supply 30.

The exemplary power supply 30 supplies power obtained from an external power source to the system part 10. The power supply 30 may include a voltage converter that converts power supplied from the external power source, such as an AC/DC adaptor, into power at a voltage level compatible with charging the battery 20. The switch 40 selectively connects the power supply line from the power supply 30 to the battery 20. The switch 40, according to an exemplary embodiment of the present general inventive concept, is switched to an off state to terminate charging the battery 20 if a charge level of the battery 20 is higher than a first predetermined value, and is switched to an on state to supply power from the battery 20 to the system part 10 if power is not supplied from the external source.

The exemplary current adjuster 50 adjusts the level of the power supplied from the power supply 30, and supplies the adjusted power to the battery 20. The current adjuster 50 adjusts the amount of the charging current downward by, for example, approximately 30 mA, and supplies the charging current to the battery 20 if the charge level of the battery 20 is less than the predetermined value. The current adjuster 50 may include a field effect transistor (FET) to modulate the charging current to the battery 20.

The exemplary power detector 60 detects whether power is supplied from the external source. The power detector 60, according to an exemplary embodiment of the present general inventive concept, detects whether the adaptor delivering power to the power supply 30, and, if so, the power is supplied to the system part 10 through the power supply 30.

The controller 70 may control the switch 40 to charge and discharge the battery 20 depending on the charge level of the battery 20. For example, the controller 70 may control the switch 40 to stop charging the battery 20 if the charge level of the battery 20 is higher than the first predetermined value.

The controller 70 may control the switch 40 according to a signal received through a system management bus indicative of the charge level of the battery 20, and a signal from the power detector 60 indicating that power is being supplied from the external source.

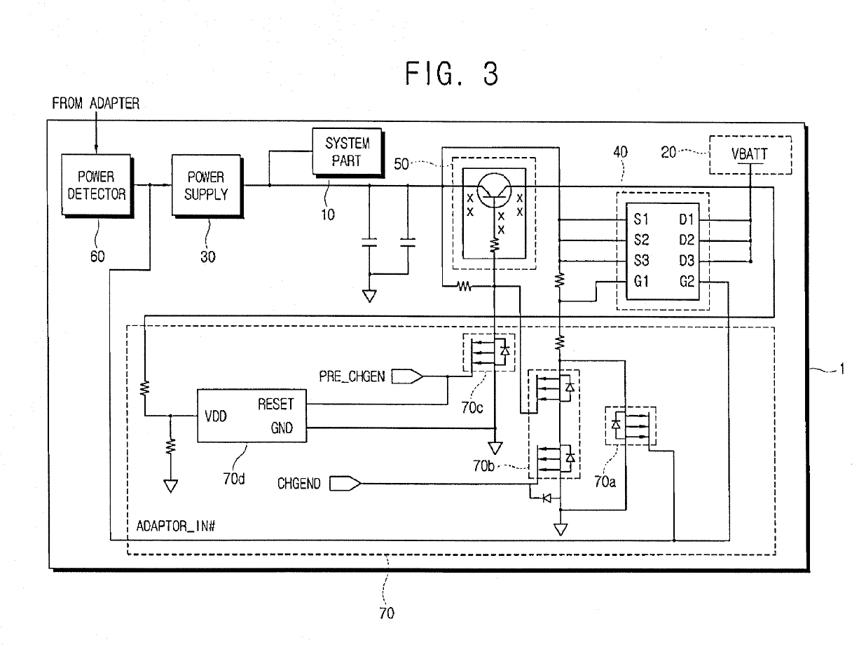

Hereinafter, an operation of the exemplary computer 1 will be described in detail with reference to the exemplary embodiment of the present general inventive concept illustrated in FIG. 3. It is to be understood that numerous modifications to, and alternatives and variations of the illustrated exemplary system will apparent to the skilled artisan upon review of this disclosure. The present inventive concept is intended to embrace all such modifications, alternatives and variations. Additionally, the schematic diagram of FIG. 3 depicts only those exemplary components central to the description of the present general inventive concept, as embodied by the exemplary circuit, and certain auxiliary circuit elements of the embodied present general inventive concept that may underlie the full implementation thereof, but are trivial to the fundamental concepts thereof, will be omitted in the interest of brevity of the description and the intelligibility of the drawing.

As illustrated in FIG. 3, adapter power that is supplied to the computer 1 is detected by the power detector 60, which provides a signal indicative thereof, ADAPTOR_IN#. Responsive to the adapter supplying external power, the controller 70 directs that power be supplied to the system part 10 and the battery 20. That is, the controller 70 receives the active low signal ADAPTOR_IN# from the power detector 60, where it is applied to a transistor 70a. The transistor 70a, upon receiving the low signal at its gate, transitions to a non-conducting state to set high a gate G1 of the switch 40. The controller 70 controls the switch 40 to be switched on between the power supply line supplying power to the system part 10 and the battery 20 to supply power to the battery 20.

The exemplary switch 40 may have one or more selectively switched terminal pairs S1-D1, S2-D2, S3-D3, each activated into a conducting state or a non-conducting state responsive to a signal on the gate terminals G1 and G2. In certain embodiments of the present invention, the gates G1 and G2 are exclusive-ORed (XOR) together such that a high at either of the gates G1 or G2 causes conduction between one or more of the terminals S1-D1, S2-D2 and S3-D3 and a low on both terminals opens the terminals S1-D1, S2-D2 and S3-D3. A high on both gates G1 and G2 would only occur in error, and, as such, such condition would also open the terminals S1-D1, S2-D2 and S3-D3.

When the external adapter is disconnected, and the system part 10 is to operate under the power supplied by the battery 20, the switch 40 is to remain closed regardless of the charge level. Thus, the switch 40 may include a second gate G2 to which the ADAPTOR_IN# signal is connected. When the adapter is removed from the computer 1, the gate G2 remains at a high state, and switch 40 remains closed regardless of the charge level of the battery 20. When the adapter is connected, however, the operation of switch 40 is responsive to the charge level of the battery 20, as is described below.

In certain embodiments of the present general inventive concept, the controller 70 obtains information regarding the charge level of the battery 20. Such information may be obtained by a suitable sensing circuit (not illustrated), or may be acquired by the controller 70 over a system maintenance bus (not illustrated). Responsive to the charge level, the controller 70 may generate one or more signals indicative thereof. For example, the controller 70 may generate a high signal, CHGEND, if the charge of the battery 20 is greater than a predetermined value indicating that the battery 20 is charged to a point where the charging operation is to terminate. The CHGEND signal may be applied to a transistor 70b, which applies the low signal to the gate G1 of the switch 40. Consequently, the switch 40 opens the connection in the power supply line between the system part 10 and the battery 20, which removes charging current from the battery 20. In certain embodiments of the present general inventive concept, the CHGEND signal is activated after the battery 20 is fully charged, which extends the life span and enhances the performance of the battery 20.

If the charge level of the battery 20 is less than a second predetermined value, the controller 70 generates a high signal, PRE_CHGEN, which is applied to a transistor 70c. The transistor 70c receiving the high signal applies a low signal to the current adjuster 50. The current adjuster 50 redirects a portion of the charging current from the power supply 30 through the transistor 70c, thereby adjusting the amount of the current supplied to the battery 20. In certain embodiments of the present general inventive concept, the PRE-CHGEN signal is generated responsive to the battery 20 being completely discharged. The battery 20 is thereby precharged with a small amount of current after being discharged and prior to recharge, thereby extending the life span and enhancing the performance of the battery 20.

It is to be understood that the controller 70 may generate other signals respectively indicative of corresponding charge levels of the battery 20, and that such signals can be used to adjust the charging current by way of the current adjuster 50 in accordance with predefined charging current profiles, each to control the amount of charging current during various phases of charging the battery 20.

The controller 70 may control the switch 40 and the current adjuster 50 according to the charge state of the battery 20 after comparing a voltage level of the battery 20 and with a predetermined voltage level through a comparator 70d.

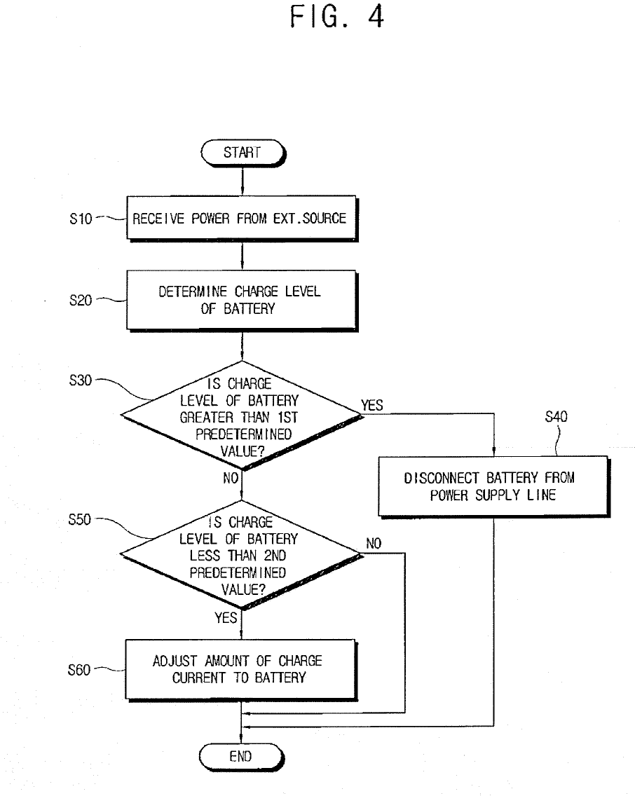

Hereinafter, a method of controlling power of the computer 1 according to the present general inventive concept will be described with reference to FIG. 4.

At operation S10, the controller 70 receives external power, such as from the adaptor, and the controller 70 may detect and receive power therefrom.

If power is supplied from the external source at operation of S10, the controller 70 determines at operation S10 the charge level of the battery 20 receiving power from a part of the power supply line supplying power to the system part 10.

If it is determined at operation S30 that the charge level of the battery 20 is higher than a first predetermined value, the process transitions to operation S40 where the controller 70 controls the switch 40 to open the connection between the power supply line supplying power to the system part 10 and the battery 20. Thus, power from the power supply 30 is removed from the battery 20 when the battery 20 is fully charged.

If it is determined at operation of S50 by the controller 70 that the charge level of the battery 20 is lower than a second predetermined value, the process transitions to operation S60 where the current adjuster 50 adjusts the level of the current charging the battery 20, so that a completely discharged battery 20 can receive a small current and be precharged therewith.

As described above, the present general inventive concept provides an electronic device, such as computer, which cuts off power supplied to a battery if the battery is fully charged, and supplies a small current to precharge the battery if the battery is completely discharged, to extend the life span of the battery, and a power control method thereof.

Although a few embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A computer, comprising:
a system part which comprises a plurality of electronic components;
a power supply which supplies power to the system part;
a battery which is connected to a power supply line between the power supply and the system part, and provides auxiliary power to the system part;
a switch to selectively connect the power supply line to the battery; and
a controller which controls the switch to charge the battery according to a charge level thereof.

2. The computer according to claim 1, wherein the controller opens the switch to stop charging the battery if the charge level thereof is higher than a first predetermined value.

3. The computer according to claim 1, further comprising:
a current adjuster which receives power from the power supply and adjusts an amount of a charging current to the battery, wherein
the controller controls the current adjuster to adjust the amount of the charging current to be supplied to the battery if the charge level thereof is lower than a second predetermined value.

4. The computer according to claim 3, further comprising:
a comparator, wherein
the controller controls the current adjuster to adjust the amount of the charging current to be supplied to the battery if the charge level of the battery is lower than the second predetermined value according to a comparison result of the comparator.

5. The computer according to claim 3, wherein each of the current adjuster and the switch comprises a transistor which is turned on and off by a control signal from the controller.

6. The computer according to claim 5, further comprising a power detector which detects whether power is supplied from an external source, wherein
the controller controls the power supply to receive power from the external source if the power detector detects that power is provided therefrom.

7. The computer according to claim 1, wherein the system part comprises a DC/DC converter which lowers a level of power supplied from the power supply.

8. A computer, comprising:
a system part which comprises a plurality of electronic components;
a power supply which supplies power to the system part;
a battery which is connected to a power supply line between the power supply and the system part, and provides auxiliary power to the system part;
a current adjuster which receives power from the power supply and adjusts an amount of a charging current to be supplied to the battery; and
a controller which controls the current adjuster to adjust the amount of the charging current to be supplied to the battery if a charge level thereof is lower than a predetermined value.

9. The computer according to claim 8, further comprising a comparator, wherein
the controller controls the current adjuster to adjust the amount of the charging current to be supplied to the battery if the charge level thereof is lower than the predetermined value according to a comparison result of the comparator.

10. The computer according to claim 8, wherein the current adjuster comprises a transistor which is turned on and off by a control signal of the controller.

11. The computer according to claim 10, further comprising a power detector which detects whether power is supplied from an external source, wherein
the controller controls the power supply to receive power from the outside if the power detector detects that power is provided therefrom.

12. The computer according to claim 8, wherein the system part comprises a DC/DC converter which lowers a level of the power supplied from the power supply.

13. A method of controlling power of a computer which includes a system part having a plurality of electronic components, and a battery, comprising:
receiving power from an external source;
determining a charge level of the battery; and
selectively connecting a power supplying line supplying power to the system part to the battery according to the determined charge level of the battery.

14. The method according to claim 13, wherein the selectively connecting the power supply line to the battery comprises terminating charging the battery by disconnecting the power supply line from the battery if the charge level thereof is higher than a first predetermined value.

15. The method according to claim 13, wherein the selectively connecting the power supply line to the battery comprises adjusting an amount of a charging current to the battery when the charge level thereof is lower than a second predetermined value.

16. The method according to claim 15, wherein the receiving of the power from the external source further comprises detecting whether the power is input from the external source, and receiving power from the external source if the input power is detected.

17. A method of controlling power of a computer which includes a system part having a plurality of electronic components, and a battery, comprising:
receiving power from an external source;
determining a charge level of the battery; and
adjusting an amount of a charging current to the battery according to the determined charge level thereof.

18. The method according to claim 17, wherein the adjusting of the amount of the charging current comprises adjusting the amount of the charging current to the battery if the charge level thereof is lower than a predetermined value.

19. An in situ battery charging apparatus, comprising:
a power supply to provide power to a system circuit and a battery that provides auxiliary power to the system circuit; and
a switch electrically interposed between the system circuit and the battery, the switch to be operated into a conducting state to provide a charging current to the battery from the power supply and a non-conducting state to remove the charging current from the battery responsive to a first charge level of the battery.

20. The battery charging apparatus according to claim 19, further comprising:
a current adjuster to adjust the charging current by a predetermined amount responsive to a second charge level of the battery.

21. The battery charging apparatus according to claim 20, wherein the first charge level is greater than the second charge level.

22. The battery charging apparatus according to claim 19, wherein the power supply provides the power to the system and the battery only if connected to an external power source.

23. The battery charging apparatus according to claim 22, further comprising:
a power detector to generate a signal activated into a first state responsive to the external power source being connected to the power supply and activated into a second state responsive to the external power source being disconnected from the power supply.

24. The battery charging apparatus according to claim 23, wherein the switch is connected to the power detector so as to operate into the conducting state responsive to the second state of the signal.

25. A method for charging a battery from power delivered to a system part of an electronic device, the method comprising:
providing an operating current to the system part and a charging current to the battery from a common power supply receiving power from an external source; and
adjusting the charging current between a maximum amount and a zero amount responsive to a charge level of the battery.

26. The method for charging a battery according to claim 25, wherein the adjusting of the charging current comprises:
adjusting the charging current by an amount less than the maximum amount by a predetermined current amount.

27. The method for charging a battery according to claim 32, wherein the adjusting the precharging amount of the charging current comprises:
adjusting the charging current by the amount of 30 milliamperes.
